(19) United States
(12) Patent Application Publication
(10) Pub. No.: US 2007/0126888 A1
(43) Pub. Date: Jun. 7, 2007

(54) Method of taking a picture when a memory of a digital camera is already full

(76) Inventor: Rick Yen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/598,656

(22) Filed: Nov. 14, 2006

(30) Foreign Application Priority Data
Dec. 2, 2005 (TW) 94142535

(51) Int. Cl. H04N 5/76

(52) U.S. Cl. 348/231.1

(57) ABSTRACT

A method of taking a picture when the memory of a digital camera is already full, includes: judging whether the memory of the digital camera is full; if yes, allowing the digital camera to continue to take a picture; next, storing the picture in an SDRAM or a DDR SDRAM of the digital camera; next, determining whether to retain the picture by using a preview function of the digital camera; if yes, selectively deleting a part of data that is stored in the memory, via a browsing function of the digital camera, for sparing the memory a predetermined space; and, storing the picture in the predetermined space. Hence, the method solves the problem that when the memory is full and the user wants to take another picture, old pictures must firstly be deleted. Hence, the user often loses the chance to take a picture that he/she wants.

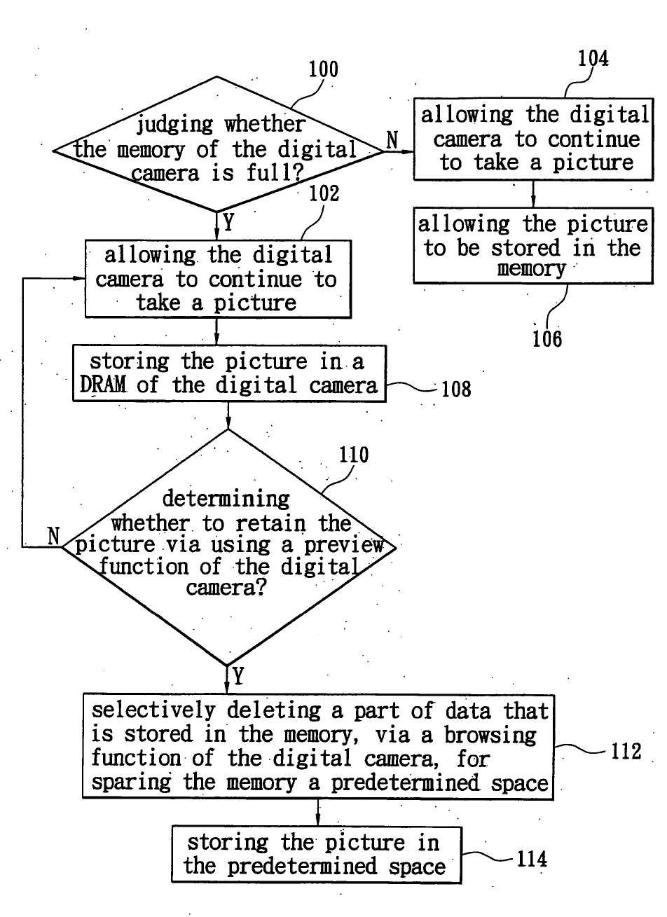

### BACKGROUND OF THE INVENTION

1. Field of the Invention

The present invention relates to a method of taking a picture when the memory of a digital camera is already full, and particularly relates to a method of allowing the digital camera to continue to take a picture and allowing the picture to be stored in a built-in or external memory of the digital camera, when the built-in or external memory is already full.

2. Description of the Related Art

There are many methods for people to commemorate an occasion. One common way is by taking pictures, because any occasion such as travel, a celebration, an event or any good time that deserves to be commemorated can be recorded via a camera. Moreover, it is convenient for users to transmit image data from the camera to an electronic device such as a computer for modifying the image data. In addition, the price of a camera has become increasingly cheaper, so the number of people using digital cameras increases day by day.

When a built-in or external memory of a digital camera is full, all picture data that is stored in the memory is very important and if the user wants to take another picture, a least one of the already stored pictures must be deleted first. Hence, the user often loses the chance to take a picture that he/she wants.

### SUMMARY OF THE INVENTION

The present invention provides a method of taking a picture when the memory of a digital camera is already full. The method allows the digital camera to continue to take a picture and allows the picture to be stored in a built-in or external memory of the digital camera, when the built-in or external memory is already full. Hence, when the user wants to take a picture, he/she does not need to firstly delete another picture. Hence, the user does not lose the chance to take a picture that he/she wants.

One aspect of the present invention is a method of taking a picture when a memory of a digital camera is already full, comprising: judging whether the memory of the digital camera is full; if the memory of the digital camera is full, allowing the digital camera to continue to take a picture; storing the picture in a DRAM (Dynamic Random Access Memory) of the digital camera; determining whether to retain the picture by using a preview function of the digital camera; if retaining the picture is determined, selectively deleting a part of data that is stored in the memory, via a browsing function of the digital camera, for sparing the memory a predetermined space; and storing the picture in the predetermined space.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

The FIGURE is a flow chart of a method of taking a picture when the memory of a digital camera is already full according to the present invention.

### DETAILED DESCRIPTION OF PREFERRED BEST MOLDS

Referring to the FIGURE, the present invention provides a method of taking a picture when a memory of a digital camera is already full, comprising: judging whether the memory of the digital camera is full (S100). If the result of S100 is yes, allowing the digital camera to continue to take a picture (S102); If the result of S100 is no, allowing the digital camera to continue to take a picture (S104) and allowing the picture to be stored in the memory (S106). In addition, the memory can be a built-in memory or an external memory.

The method of the present invention further comprises: storing the picture in a DRAM (Dynamic Random Access Memory) of the digital camera (S108). In addition, the DRAM can be an SDRAM (Synchronous Dynamic Random Access Memory) or a DDR (Double Data Rate) SDRAM.

The method of the present invention further comprises: determining whether to retain the picture by using a preview function of the digital camera (S110). If the result of S110 is yes, selectively deleting a part of data that is stored in the memory, via a browsing function of the digital camera, for sparing the memory a predetermined space (S 112). If the result of S110 is no, returning to S102 for allowing the digital camera to continue to take a picture. Finally, the method comprises storing the picture in the predetermined space (S114).

In conclusion, the method of the present invention allows the digital camera to continue to take a picture and allows the picture to be stored in a built-in or external memory of the digital camera, when the built-in or external memory is already full. Hence, when the user wants to take a picture, he/she does not need to firstly delete present picture. Hence, the user does not lose the chance to take a picture that he/she wants.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of taking a picture when a memory of a digital camera is already full, comprising:
judging whether the memory of the digital camera is full;
if the memory of the digital camera is full, allowing the digital camera continues to take a picture; and
storing the picture in a DRAM (Dynamic Random Access Memory) of the digital camera.

2. The method as claimed in claim 1, wherein after the step of storing the picture in the DRAM, the method further comprises:
determining whether to retain the picture by using a preview function of the digital camera;
if retaining the picture is determined, selectively deleting a part of data that is stored in the memory, via a browsing function of the digital camera, for sparing the memory a predetermined space; and
storing the picture in the predetermined space.

3. The method as claimed in claim 2, wherein if the step of determining whether to retain the picture is no, allowing the digital camera to continue to take a picture.

4. The method as claimed in claim 1, wherein the memory is a built-in memory or an external memory.

5. The method as claimed in claim 1, wherein the DRAM is an SDRAM (Synchronous Dynamic Random Access Memory) or a DDR (Double Data Rate) SDRAM.

6. The method as claimed in claim 1, wherein if the memory of the digital camera is not full, allowing the digital camera to continue to take a picture and allowing the picture to be stored in the memory.
